(19) United States
(12) Patent Application Publication
(10) Pub. No.: US 2025/0080223 A1
(43) Pub. Date: Mar. 6, 2025

(54) OPTICAL RECEIVING APPARATUS, OPTICAL RECEIVING METHOD AND OPTICAL TRANSMISSION SYSTEM

(71) Applicant: NIPPON TELEGRAPH AND TELEPHONE CORPORATION, Tokyo (JP)

(72) Inventors: Toshiaki SHITABA, Musashino-shi, Tokyoe (JP); Tomoaki YOSHIDA, Musashino-shi, Tokyo (JP); Yoichi FUKADA, Musashino-shi, Tokyo (JP); Akihiro TANABE, Musashino-shi, Tokyo (JP); Ryo MIYATAKE, Musashino-shi, Tokyo (JP)

(73) Assignee: NIPPON TELEGRAPH AND TELEPHONE CORPORATION, Tokyo (JP)

(21) Appl. No.: 18/726,016

(22) PCT Filed: Jan. 11, 2022
(86) PCT No.: PCT/JP2022/000587

§ 371 Date: Jul. 1, 2024

(51) Int. Cl. H04B 10/2507; H04B 10/079

(52) U.S. Cl. CPC H04B 10/2507; H04B 10/07955

(57) ABSTRACT

An optical receiving apparatus includes: a first branching unit that branches an input optical signal into a first optical signal and a second optical signal; a reception amplification unit that amplifies power of the first optical signal; a compensation unit that compensates for wavelength distortion of the first optical signal whose power has been amplified; a first detection unit that detects power of the second optical signal; a first control unit that controls an amount of compensation for the wavelength distortion on the basis of the power of the second optical signal; a second branching unit that branches the first optical signal compensated for the wavelength distortion into a third optical signal and a fourth optical signal; a second detection unit that detects power of the third optical signal; and a second control unit that controls an amplification factor of the power of the first optical signal before the compensation for the wavelength distortion on the basis of the power of the third optical signal.

### TECHNICAL FIELD

The present invention relates to an optical receiving apparatus, an optical reception method, and an optical transmission system.

### BACKGROUND ART

An optical transmission system using a method of collectively converting frequency division multiplexing (FDM) signals into frequency modulation (FM) signals (hereinafter, such a method will be referred to as an “FM batch conversion method”) is introduced into a video signal distribution system (see Non Patent Literature 1).

In such an optical transmission system, there is a case where an optical transmitting apparatus (Optical TA) converts a frequency multiplexing signal (carrier wave signal) input from a head end (HE) into a broadband frequency modulation signal. The optical transmitting apparatus converts the broadband frequency modulation signal into an optical signal. The optical transmitting apparatus outputs the converted optical signal to a transmission path of a relay section.

A video-optical line terminal (V-OLT) outputs the optical signal output to the transmission path of the relay section to an access section. Here, the video-optical line terminal may compensate for waveform distortion due to wavelength dispersion generated in the optical signal in the relay section.

The optical signal transmitted through the access section is input to a video-optical network unit. The video-optical network unit demodulates the input optical signal. The video-optical network unit generates the original frequency multiplexing signal (carrier wave signal) by demodulating the optical signal. Here, video-optical line terminals are connected in multiple stages in the relay section, and thus long-distance transmission of the optical signal is possible.

### CITATION LIST

### Non Patent Literature

Non Patent Literature 1: “Transmission equipment for transferring multi-channel television signals over optical access networks by frequency modulation conversion”, ITU-T Rec. J. 185, 2012.

### SUMMARY OF INVENTION

### Technical Problem

However, in the optical transmission system, the distance of a section from the video-optical line terminal to the video-optical network unit is not constant. Therefore, the power of the optical signal input to the video-optical network unit is not constant, and thus the quality of the frequency multiplexing signal (carrier wave signal) output from the video-optical network unit is not constant.

In general, as a distance from a video-optical line terminal to a video-optical network unit is longer, the power of an optical signal input to the video-optical network unit is attenuated due to a loss caused by a transmission path. As described above, there is a case where a transmission distance of an optical signal cannot be extended.

In view of the above circumstances, an object of the present invention is to provide an optical receiving apparatus, an optical reception method, and an optical transmission system capable of extending a transmission distance of an optical signal.

### Solution to Problem

One aspect of the present invention is an optical receiving apparatus including: a first branching unit that branches an input optical signal into a first optical signal and a second optical signal; a reception amplification unit that amplifies power of the first optical signal; a compensation unit that compensates for wavelength distortion of the first optical signal whose power has been amplified; a first detection unit that detects power of the second optical signal; a first control unit that controls an amount of compensation for the wavelength distortion on the basis of the power of the second optical signal; a second branching unit that branches the first optical signal compensated for the wavelength distortion into a third optical signal and a fourth optical signal; a second detection unit that detects power of the third optical signal; and a second control unit that controls an amplification factor of the power of the first optical signal before the compensation for the wavelength distortion on the basis of the power of the third optical signal.

One aspect of the present invention is an optical reception method executed by an optical receiving apparatus, the optical reception method including: a step of branching an input optical signal into a first optical signal and a second optical signal; a step of amplifying power of the first optical signal; a step of compensating for wavelength distortion of the first optical signal whose power has been amplified; a step of detecting power of the second optical signal; a step of controlling an amount of compensation for the wavelength distortion on the basis of the power of the second optical signal; a step of branching the first optical signal compensated for the wavelength distortion into a third optical signal and a fourth optical signal; a step of detecting power of the third optical signal; and a step of controlling an amplification factor of the power of the first optical signal before the compensation for the wavelength distortion on the basis of the power of the third optical signal.

One aspect of the present invention is an optical reception method executed by an optical transmission system including an optical transmitting apparatus and an optical receiving apparatus, wherein the optical transmitting apparatus generates a frequency modulation signal, and transmits an input optical signal whose intensity has been modulated according to the frequency modulation signal, and the optical receiving apparatus branches the input optical signal into a first optical signal and a second optical signal, amplifies power of the first optical signal, compensates for wavelength distortion of the first optical signal whose power has been amplified, detects power of the second optical signal, controls an amount of compensation for the wavelength distortion on the basis of the power of the second optical signal, branches the first optical signal compensated for the wavelength distortion into a third optical signal and a fourth optical signal, detects power of the third optical signal, and controls an amplification factor of the power of the first optical signal before the compensation for the wavelength distortion on the basis of the power of the third optical signal.

One aspect of the present invention is an optical transmission system including an optical transmitting apparatus and an optical receiving apparatus, the optical transmitting apparatus including: a frequency modulation unit that generates a frequency modulation signal; and an intensity modulator that transmits an input optical signal whose intensity has been modulated according to the frequency modulation signal, the optical receiving apparatus including: a first branching unit that branches the input optical signal into a first optical signal and a second optical signal; a reception amplification unit that amplifies power of the first optical signal; a compensation unit that compensates for wavelength distortion of the first optical signal whose power has been amplified; a first detection unit that detects power of the second optical signal; a first control unit that controls an amount of compensation for the wavelength distortion on the basis of the power of the second optical signal; a second branching unit that branches the first optical signal compensated for the wavelength distortion into a third optical signal and a fourth optical signal; a second detection unit that detects power of the third optical signal; and a second control unit that controls an amplification factor of the power of the first optical signal before the compensation for the wavelength distortion on the basis of the power of the third optical signal.

### Advantageous Effects of Invention

According to the present invention, it is possible to extend a transmission distance of an optical signal.

### BRIEF DESCRIPTION OF DRAWINGS

FIG. 1 is a diagram illustrating a configuration example of an optical transmission system according to an embodiment.

FIG. 2 is a diagram illustrating a configuration example of an optical receiving apparatus according to the embodiment.

FIG. 3 is a sequence diagram illustrating an operation example of the optical transmission system according to the embodiment.

FIG. 4 is a diagram illustrating a hardware configuration example of the optical receiving apparatus according to the embodiment.

### DESCRIPTION OF EMBODIMENTS

An embodiment of the present invention will be described in detail with reference to the drawings.

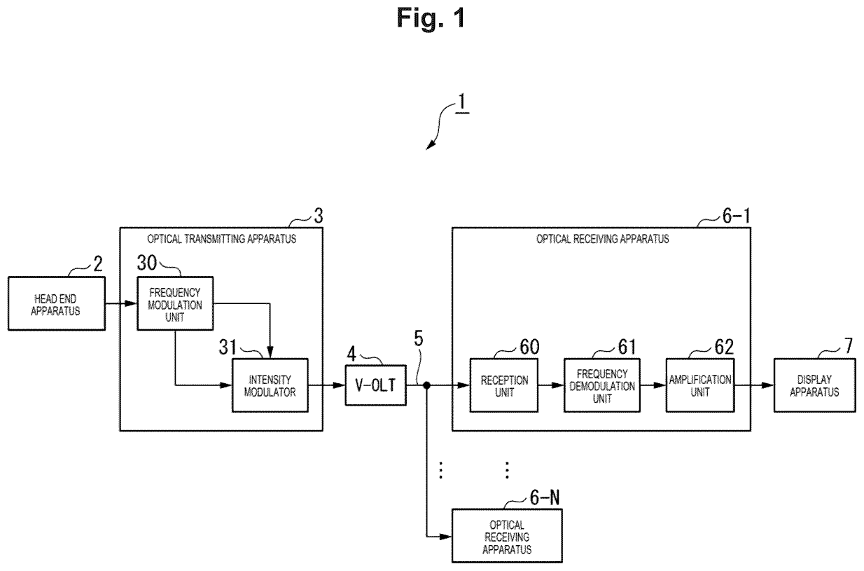

FIG. 1 is a diagram illustrating a configuration example of an optical transmission system 1. The optical transmission system 1 is a system (optical transmission network) that transmits an optical signal. Hereinafter, as an example, the optical transmission system distributes a video signal by using an optical signal. The video may be a moving image or a still image.

The optical transmission system 1 includes a head end apparatus 2, an optical transmitting apparatus 3, a V-OLT 4, a transmission path 5, N (N is an integer of 1 or more) optical receiving apparatuses 6, and a display apparatus 7. The optical transmitting apparatus 3 includes a frequency modulation unit 30 and an intensity modulator 31. Each of the optical receiving apparatuses 6 includes a reception unit 60, a frequency demodulation unit 61, and an amplification unit 62.

Hereinafter, a section from the optical transmitting apparatus 3 to the V-OLT 4 will be referred to as a “relay section”. Hereinafter, a section from the V-OLT 4 to each of the optical receiving apparatuses 6 will be referred to as an “access section”.

The head end apparatus 2 (equipment of a broadcasting distributor) outputs a frequency multiplexing signal including a video signal to the optical transmitting apparatus 3. Note that the head end apparatus 2 may output a frequency multiplexing signal including an audio signal, a data signal, a video signal, and the like to the optical transmitting apparatus 3.

The optical transmitting apparatus 3 is an apparatus (TA) that transmits an optical signal. The frequency multiplexing signal is input from the head end apparatus 2 to the frequency modulation unit 30. The frequency modulation unit 30 generates a frequency modulation signal (FM signal) by executing optical heterodyne detection processing on the frequency multiplexing signal.

The frequency modulation unit 30 generates a laser beam for transmission. The intensity modulator 31 executes intensity modulation on the laser beam for transmission according to the frequency modulation signal generated by the frequency modulation unit 30. As a result, the intensity modulator 31 generates an intensity-modulated optical signal. The intensity modulator 31 transmits the intensity-modulated optical signal to the V-OLT 4.

The V-OLT 4 is a video-optical line terminal. The V-OLT 4 transmits the optical signal whose intensity has been modulated by the intensity modulator 31 to each of the optical receiving apparatuses 6 via the transmission path 5. The transmission path 5 transmits the optical signal by using an optical fiber. The transmission path 5 uses an optical splitter to distribute the optical signal to each of the optical receiving apparatuses 6 from an optical receiving apparatus 6-1 to an optical receiving apparatus 6-N.

Each of the optical receiving apparatuses 6 (video-optical network units) is a video-optical network unit. The reception unit 60 includes a photodiode. The reception unit 60 converts the optical signal acquired via the transmission path 5 into a frequency modulation signal (electric signal). The frequency demodulation unit 61 generates the frequency multiplexing signal including the video signal by executing demodulation processing (delay detection) on the frequency modulation signal. The amplification unit 62 amplifies the voltage of the video signal in the frequency multiplexing signal to a predetermined level.

The display apparatus 7 is an apparatus that displays a video on a screen. The display apparatus 7 acquires, from the amplification unit 62, the frequency multiplexing signal including the video signal whose voltage has been amplified to the predetermined level. The display apparatus 7 displays the video on the screen in accordance with the video signal in the frequency multiplexing signal.

Next, a configuration example of one optical receiving apparatus 6 will be described.

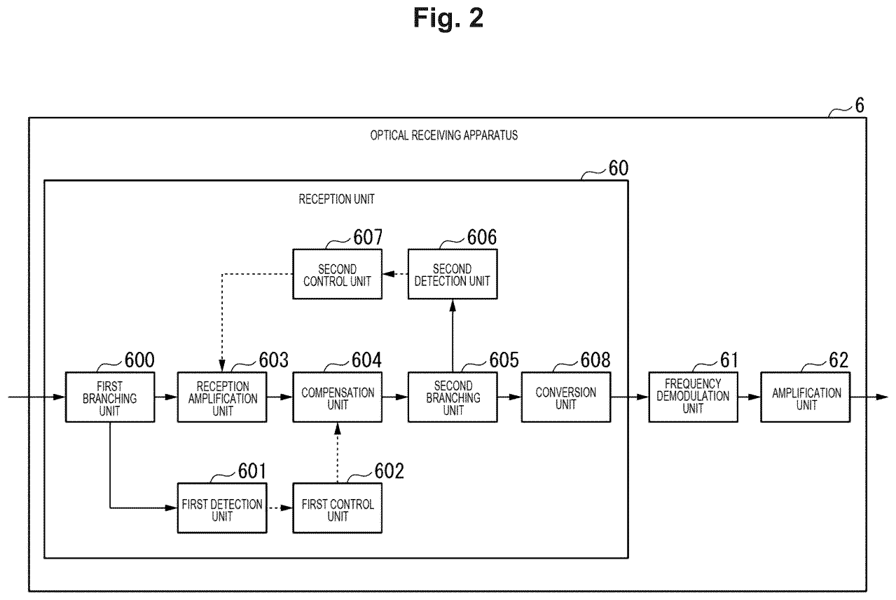

FIG. 2 is a diagram illustrating the configuration example of the optical receiving apparatus 6 according to the embodiment. The reception unit 60 includes a first branching unit 600, a first detection unit 601, a first control unit 602, a reception amplification unit 603, a compensation unit 604, a second branching unit 605, a second detection unit 606, a second control unit 607, and a conversion unit 608.

The first branching unit 600 branches an optical signal (input optical signal) input from the V-OLT 4 into a first optical signal and a second optical signal. That is, the first branching unit 600 distributes the first optical signal branched from the input optical signal to the reception amplification unit 603. The first branching unit 600 distributes the second optical signal branched from the input optical signal to the first detection unit 601.

The first detection unit 601 detects power “Pᵣ₁” (dBm) of the second optical signal. The first control unit 602 derives a transmission distance “L” (km) of the access section on the basis of the power “Pᵣ₁” of the second optical signal. For example, the transmission distance “L” of the access section is expressed by an expression “L=(Pₒᵤₜ−Pᵣ₁-A)/α”. Here, “Pₒᵤₜ” represents the power of the optical signal output from the V-OLT 4. The power “Pₒᵤₜ” is determined in advance. “A” represents a branch loss (dB) in the access section. “α” represents a loss (dB/km) per unit length of the access section. The first control unit 602 derives the amount of compensation for waveform distortion on the basis of a control signal indicating the transmission distance “L” of the access section. The amount of compensation for the waveform distortion due to wavelength dispersion is proportional to, for example, the transmission distance “L” of the access section. The first control unit 602 outputs a control signal indicating the amount of compensation to the compensation unit 604.

A control signal indicating an amplification factor is input to the reception amplification unit 603 from the second control unit 607. The reception amplification unit 603 amplifies the power of the first optical signal on the basis of the amplification factor. The control signal indicating the amount of compensation is input to the compensation unit 604 (variable dispersion compensation unit) from the first control unit 602. The compensation unit 604 compensates for the wavelength distortion of the first optical signal whose power has been amplified by the reception amplification unit 603 on the basis of the amount of compensation.

The second branching unit 605 branches the first optical signal compensated for the wavelength distortion into a third optical signal and a fourth optical signal. That is, the second branching unit 605 distributes the branched third optical signal to the second detection unit 606. The second branching unit 605 distributes the branched fourth optical signal to the conversion unit 608.

The second detection unit 606 detects power “Pᵣ₂” (dBm) of the third optical signal. The second control unit 607 derives an amplification factor “G” in the reception amplification unit 603 on the basis of the power “Pᵣ₂” of the third optical signal. The amplification factor “G” is expressed by, for example, an expression “G=Pᵣ₃−Pᵣ₂”. Here, “Pᵣ₃” represents an optimum value (dB) of optical power input to the conversion unit 608. The optimum value “Pᵣ₃” is determined in advance.

The conversion unit 608 converts the fourth optical signal into an electric signal. The frequency demodulation unit 61 demodulates a frequency multiplexing signal from the electric signal. The amplification unit 62 amplifies the level of the frequency multiplexing signal.

Next, an operation example of the optical transmission system 1 will be described.

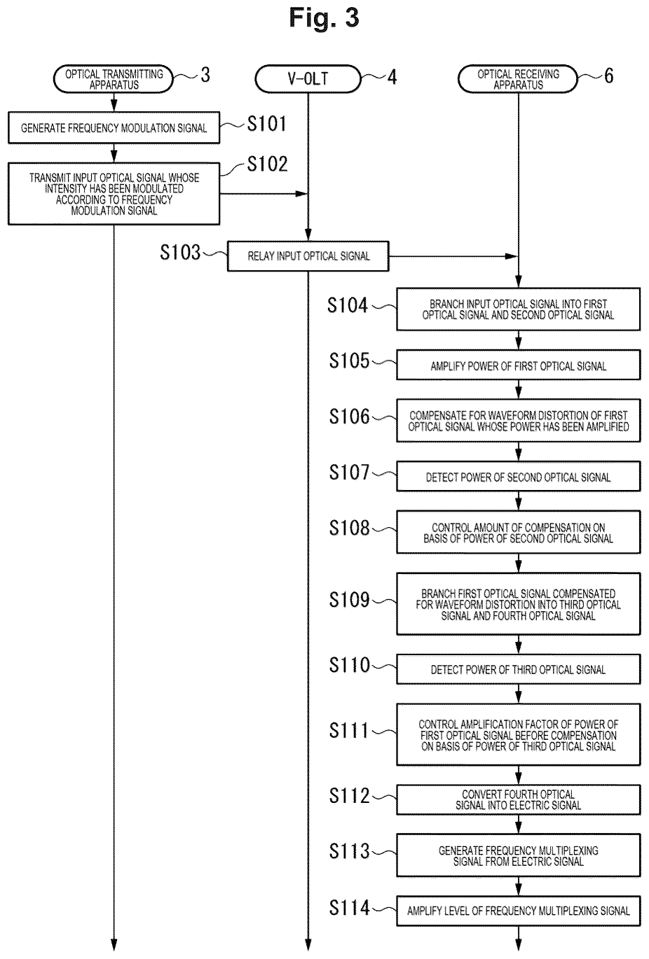

FIG. 3 is a sequence diagram illustrating the operation example of the optical transmission system 1 according to the embodiment. The optical transmitting apparatus 3 generates a frequency modulation signal from a frequency multiplexing signal (carrier wave signal) input from the head end apparatus 2 (step S101). The optical transmitting apparatus 3 transmits an input optical signal whose intensity has been modulated according to the frequency modulation signal to the V-OLT 4 (step S102). The V-OLT 4 relays the input optical signal to each of the optical receiving apparatuses 6 (step S103).

The optical receiving apparatus 6 branches the input optical signal into a first optical signal and a second optical signal (step S104). The optical receiving apparatus 6 amplifies the power of the first optical signal (step S105). The optical receiving apparatus 6 compensates for waveform distortion of the first optical signal whose power has been amplified (step S106). The optical receiving apparatus 6 detects the power of the second optical signal (step S107). The optical receiving apparatus 6 controls the amount of compensation for the waveform distortion of the first optical signal on the basis of the power of the second optical signal (step S108).

The optical receiving apparatus 6 branches the first optical signal compensated for the waveform distortion into a third optical signal and a fourth optical signal (step S109). The optical receiving apparatus 6 detects the power of the third optical signal (step S110). The optical receiving apparatus 6 controls an amplification factor of the power of the first optical signal before the compensation on the basis of the power of the third optical signal (step S111).

The optical receiving apparatus 6 converts the fourth optical signal into an electric signal (step S112). The optical receiving apparatus 6 generates the frequency multiplexing signal from the electric signal (step S113). The optical receiving apparatus 6 amplifies the level of the frequency multiplexing signal (step S114).

As described above, the frequency modulation unit 30 generates the frequency modulation signal from the frequency multiplexing signal. The intensity modulator 31 transmits the input optical signal whose intensity has been modulated according to the frequency modulation signal. The V-OLT 4 relays the intensity-modulated input optical signal.

The first branching unit 600 branches the input optical signal into the first optical signal and the second optical signal. The reception amplification unit 603 amplifies the power of the first optical signal. The compensation unit 604 compensates for the wavelength distortion of the first optical signal whose power has been amplified. The first control unit 602 controls the amount of compensation for the wavelength distortion on the basis of the power of the second optical signal.

As described above, the reception amplification unit 603 is arranged immediately after (subsequent to) the first branching unit 600, and thus the power of the optical signal input to the reception amplification unit 603 is stronger than in a case where the reception amplification unit 603 is arranged other than immediately after the first branching unit 600. Therefore, the low-noise property is improved. In addition, the optical receiving apparatus 6 dynamically adjusts the amount of compensation for the wavelength dispersion according to the distance of the access section.

The second branching unit 605 branches the first optical signal compensated for the wavelength distortion into the third optical signal and the fourth optical signal. The second control unit 607 controls the amplification factor of the power of the first optical signal before the compensation unit 604 compensates for the wavelength distortion, on the basis of the power of the third optical signal. That is, the second control unit 607 controls the amplification factor of the power of the first optical signal in the reception amplification unit 603.

As described above, the second branching unit 605 is arranged immediately after (subsequent to) the compensation unit 604, and thus, even in a case where the transmission loss value of the optical signal changes according to the amount of compensation in the compensation unit 604, the power (optical power) of the optical signal input to the conversion unit 608 is constant. That is, the optical receiving apparatus 6 makes the power of the optical signal input to the conversion unit 608 of the optical receiving apparatus 6 constant regardless of the distance (transmission loss value) of the access section.

Therefore, the optical receiving apparatus 6 makes the quality of the frequency multiplexing signal (video signal) to be output constant regardless of the distance of the access section. This makes it possible to extend a transmission distance of the optical signal. In addition, the optical transmission system 1 can be used in more areas.

### Hardware Cconfiguration Example

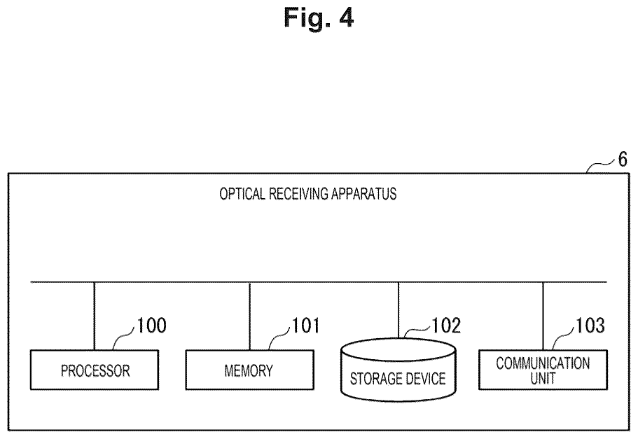

FIG. 4 is a diagram illustrating a hardware configuration example of one optical receiving apparatus 6 according to the embodiment. Some or all of the functional units of the optical receiving apparatus 6 are implemented as software by a processor 100 such as a central processing unit (CPU) executing a program stored in a storage device 102 including a non-volatile recording medium (non-transitory recording medium) and a memory 101. The program may be recorded in a computer-readable recording medium. The computer-readable recording medium is, for example, a portable medium such as a flexible disk, a magneto-optical disc, a read-only memory (ROM), or a compact disc read-only memory (CD-ROM), or a non-transitory recording medium such as a storage device such as a hard disk built in a computer system. A communication unit 103 executes communication processing.

Some or all of the functional units of the optical receiving apparatus 6 may be implemented by use of hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

Although the embodiment of the present invention has been described in detail with reference to the drawings, specific configurations are not limited to the embodiment, and include design and the like within a range not departing from the gist of the present invention.

### INDUSTRIAL APPLICABILITY

The present invention is applicable to an optical transmission system.

### REFERENCE SIGNS LIST

1 Optical transmission system
2 Head end apparatus
3 Optical transmitting apparatus
4 V-OLT
5 Transmission path
6 Optical receiving apparatus
7 Display apparatus
30 Frequency modulation unit
31 Intensity modulator
60 Reception unit
61 Frequency demodulation unit
62 Amplification unit
100 Processor
101 Memory
102 Storage device
103 Communication unit
600 First branching unit
601 First detection unit
602 First control unit
603 Reception amplification unit
604 Compensation unit
605 Second branching unit
606 Second detection unit
607 Second control unit

1. An optical receiving apparatus comprising:
a first branching unit that branches an input optical signal into a first optical signal and a second optical signal;
a reception amplification unit that amplifies power of the first optical signal;
a compensation unit that compensates for wavelength distortion of the first optical signal whose power has been amplified;
a first detection unit that detects power of the second optical signal;
a first control unit that controls an amount of compensation for the wavelength distortion on a basis of the power of the second optical signal;
a second branching unit that branches the first optical signal compensated for the wavelength distortion into a third optical signal and a fourth optical signal;
a second detection unit that detects power of the third optical signal; and
a second control unit that controls an amplification factor of the power of the first optical signal before the compensation for the wavelength distortion on a basis of the power of the third optical signal.

2. An optical reception method executed by an optical receiving apparatus,
the optical reception method comprising:
a step of branching an input optical signal into a first optical signal and a second optical signal;
a step of amplifying power of the first optical signal;
a step of compensating for wavelength distortion of the first optical signal whose power has been amplified;
a step of detecting power of the second optical signal;
a step of controlling an amount of compensation for the wavelength distortion on a basis of the power of the second optical signal;
a step of branching the first optical signal compensated for the wavelength distortion into a third optical signal and a fourth optical signal;
a step of detecting power of the third optical signal; and
a step of controlling an amplification factor of the power of the first optical signal before the compensation for the wavelength distortion on a basis of the power of the third optical signal.

3. An optical reception method executed by an optical transmission system including an optical transmitting apparatus and an optical receiving apparatus, wherein
the optical transmitting apparatus
generates a frequency modulation signal, and
transmits an input optical signal whose intensity has been modulated according to the frequency modulation signal, and
the optical receiving apparatus
branches the input optical signal into a first optical signal and a second optical signal,
amplifies power of the first optical signal,
compensates for wavelength distortion of the first optical signal whose power has been amplified,
detects power of the second optical signal,
controls an amount of compensation for the wavelength distortion on a basis of the power of the second optical signal,
branches the first optical signal compensated for the wavelength distortion into a third optical signal and a fourth optical signal,
detects power of the third optical signal, and
controls an amplification factor of the power of the first optical signal before the compensation for the wavelength distortion on a basis of the power of the third optical signal.

4. (canceled)
